(19) United States
(12) Patent Application Publication
(10) Pub. No.: US 2017/0088099 A1
(43) Pub. Date: Mar. 30, 2017

(54) Vehicle Key Apparatus

(71) Applicant: Yaowu Ma, Zhengzhou (CN)

(72) Inventors: Yaowu Ma, Zhengzhou (CN); Fen Ruan, Zhengzhou (CN); Jun Ma, Zhengzhou (CN); Pinzhen Huang, Zhengzhou (CN); Qianjing Ma, Zhengzhou (CN); Qianjia Ma, Zhengzhou (CN); George Ma, Zhengzhou (CN); Yong Wu, Zhengzhou (CN); Xuemei Ma, Zhengzhou (CN)

(21) Appl. No.: 15/310,784

(22) PCT Filed: Apr. 10, 2015
(86) PCT No.: PCT/CN2015/076216

§ 371 Date: Nov. 14, 2016

(30) Foreign Application Priority Data
Apr. 11, 2014 (CN) 201410142264.0

(51) Int. Cl. B60R 25/23; B60R 25/24; E05B 81/76; B60R 25/20; E05B 37/16; E05B 49/00

(52) U.S. Cl. CPC B60R 25/23; E05B 37/16; E05B 49/00; E05B 81/76; B60R 25/209; B60R 25/24; B60R 2325/101; B60R 2325/105

(57) ABSTRACT

A vehicle key apparatus, mounted on an outer wall of a vehicle and a driver dashboard of the vehicle and the surroundings, including an electronic cipher keyboard, an RFID reader/writer (20), a biological features recognizer, wherein a portable electronic key comprises multi-functional appliances such as a mobile phone, a watch and the like, and an anti-theft system lock extension switch (5) is set beside an engine switch (3) of the vehicle; the door lock of the vehicle, the anti-theft system lock, the engine, the air-conditioner and the cargo hold are opened and closed and recorder data is read and so forth by means of the cipher, RFID, biological features, remote control, radio induction and the like. Due to the convenient use of the apparatus, there is no need or less need to carry keys, which enhances the performance of key management.

### FIELD OF THE INVENTION

The present invention relates to a vehicle key apparatus, which is suitable for motor vehicles like cars and motorcycles with 2 wheels, 3 wheels, 4 wheels and above, and driven by burning fuel, burning gas or electric force, and vehicles like trains, ships and airplanes.

### BACKGROUND OF THE INVENTION

Car keys at present are mainly remote control keys and keyless starting system keys. Although the remote key and the keyless starting system key have many advantages, they also have many disadvantages. The remote control key and the keyless starting system key must be carried on a person to unlock a car door lock. Sometimes, the remote control key and the keyless starting system key may be left in the car, the car door is locked, and the key may also be lost. When a car owner can not open the car door and ask for help from others, it will be a lot of time and money, and will cause unrest.

Thus, some people arrange electronic combination keyboards or fingerprint recognition devices on the car as car keys. But because of the inconvenience of operation, the high cost, the low security, and the inconvenience of lending them to others, these kinds of keys can not be in broad and practical use, and can not substitute the present remote control keys and the keyless starting system keys well.

### SUMMARY OF THE INVENTION

To address the deficiencies of the prior art, the present invention provides a manner which is convenient to use, has good anti-theft performance, doesn't need or reduces the carrying of keys, enhances key management, and is able to unlock vehicle door locks and anti-theft system locks.

To address the above-mentioned technical problems, the present invention employs the following technical solutions: vehicle key apparatus comprises electronic combination keyboards both on an outer wall of the vehicle and on or around a vehicle driver instrument panel; wherein said keyboard is touch keypad or mechanical keypad; and through combination operation, said keyboards performs one or more of unlocking and locking the vehicle door lock, unlocking and locking the anti-theft system lock, starting and stopping an engine, making the vehicle be in a running possible state, starting an air conditioner, adjusting air conditioner temperature, unlocking a car glove box lock, and unlocking a cargo door lock.

Said keyboard on the outer wall of the vehicle, whether it is powered by an internal power supply of the vehicle, is powered by one or more of a solar power generation assembly, a manual mechanical power generation assembly, a thermoelectric power generation assembly, a battery removable from the outside, and an external power supply connected to an external power supply socket.

Said keyboard on or around the vehicle instrument panel is special, or is one function of a multi-functional audio or video device of the car, and is powered by one or both of the internal power supply of the vehicle and a special battery of the keyboard.

Between said keyboards and the vehicle anti-theft system lock device, one or more of a wired communication employing rolling codes and fixed codes, and a wireless communication employing rolling codes are used.

Vehicle key apparatus comprises a portable electronic key, which is the remote control key without or with the electronic combination keyboard, or the keyless starting system key, or one function of one or more of the multi-functional electric appliance of a telephone, a smartphone, a tablet computer, a computer, a smart watch, a digital camera and a digital multimedia player; wherein between said portable electronic key and the vehicle anti-theft system lock device, one or more communication modes of a RFID communication, a radio frequency communication, an infrared light communication, a Bluetooth communication, a WIFI communication, a telephone ground-based communication and a telephone satellite communication are used; one or both of a wireless communication operated by the keypad and an approaching wireless induction are provided; one or both of using the combination and not using the combination are used; to perform one or more of unlocking and locking the anti-theft system lock, unlocking and locking the vehicle door lock, starting and stopping the engine, making the vehicle be in the running possible state, starting the air conditioner, adjusting air conditioner temperature, unlocking the car glove box lock, unlocking the cargo door lock and reading recorder data.

Vehicle key apparatus comprises an anti-theft system lock unlocking extending switch near vehicle engine switch.

Vehicle key apparatus comprises an anti-theft starting switch on or around the driver instrument panel of the vehicle; wherein said switch has one or more of said engine switch, anti-theft system lock switch and said extending switch, and is one of the following kinds: (1) different positions in the same knob, (2) different positions in the same translation button, (3) different positions in the same button, (4) different button hold times in the same button, (5) different times of the button to be pressed during a set time in the same button, (6) an operating button consisting of one or more of the operations of pressing, rotating and translating the button, and (7) a separated operating button in the button, the knob and the translation button.

After said keyboard on the outer wall of the vehicle or said portable electronic key is used to unlock the door lock with the input of a vehicle door lock combination or without the input of a combination and within a set time A, before people's entering into the car, or after people's entering into the car, said keyboard on the outer wall of the vehicle or on or around the vehicle driver instrument panel, or said portable electronic key is used to unlock the anti-theft system lock with the input of the anti-theft system lock combination or without the input of the combination; then within a set time B, said engine switch is operated to start the engine, or said extending switch is operated to extend an anti-theft system unlocked state time, or said anti-theft system lock switch is operated to lock the anti-theft system.

When said vehicle stops running and the engine is in running state, said engine switch is operated to stop the engine to the unlocked state of the anti-theft system lock. Then within a set time B, said engine switch is operated to start the engine, or said extending switch is operated to extend the anti-theft system lock unlocked state time, or said anti-theft system lock switch is operated to lock the engine.

Within said set time A, if no operation is done, and when said set time A passes, said vehicle door lock is locked automatically with or without an announce in advance.

Within said set time B, if no operation is done, and when the set time B passes, said anti-theft system lock is locked automatically with or without an announce in advance.

Said door-locking operation of the vehicle achieves one or more of the following results: (1) when the engine stops running and the anti-theft system lock is in an unlocked state, and the vehicle door undergoes processes of being opened and closed, said door-locking operation locks the door lock and the anti-theft system at the same time; (2) when the engine stops running and the anti-theft system lock is in the unlocked state, and the vehicle door does not undergo the processes of being opened and closed, said door-locking operation does not lock the anti-theft system; (3) when the engine is running, and the vehicle door undergoes or doesn't undergo the processes of being opened and closed, said door-locking operation does not stop the engine and does not lock the anti-theft system; and (4) when the engine is in the state of stopping running, and the vehicle door is in an opening state, said door-locking operation locks the anti-theft system, and then if do the door close operation, the door lock also locks automatically.

Said door opening and closing operation of the vehicle achieves one or more of the following results: (1) when the engine stops running, said door opening and closing operation locks the anti-theft system and the door automatically after the set time C; and (2) when the engine is running, said door opening and closing operation does not stop the engine and does not lock the anti-theft system.

Said operation of locking both anti-theft system and door lock, also closes all of vehicle windows automatically.

In the state that anti-theft system and door lock of the vehicle are locked, people use said key device to open or close a window inside or outside the vehicle.

Said portable electronic key undergoes one or more of the following operations through an induction with the vehicle within a set time after an input of combination or an input of no combination: (1) when said portable electronic key approaches the automobile for a certain distance, the door lock is unlocked automatically; (2) when said portable electronic key enters the car, the anti-theft system lock is unlocked automatically; (3) when the engine stops running and said portable electronic key exits the car, the anti-theft system lock is locked automatically; (4) when the engine is running, said portable electronic key exits the car, the engine is not stopped, the anti-theft system is not locked, and the car gives or does not give the prompting message that said portable electronic key exits the car; (5) when said portable electronic key leaves the car for a certain distance, the door lock is locked automatically; and (6) said portable electronic key has one or more of a hardware operation key and a software operation key, and the result of a manual operation has precedence over that of an automatic operation.

Vehicle key apparatus comprises an electronic combination keyboard on the vehicle or portable electronic key; wherein when the door lock and the anti-theft system lock are in locked states at the same time, with said keyboard or said portable electronic key, only unlocking operation of the anti-theft system lock, starting or not starting the engine, does not make the vehicle be in the running possible state.

Vehicle key apparatus comprises an electronic combination keyboard on the vehicle or portable electronic key; wherein when the door lock and the anti-theft system lock are in locked states at the same time, with said keyboard or said portable electronic key, first unlocking the anti-theft system lock, starting or not starting the engine or the air conditioner, then unlocking the door lock make the vehicle be in the running possible state.

Vehicle key apparatus comprises a rotary mechanical password door lock or a keypad type mechanical password door lock on the outer wall of the vehicle, to unlock the vehicle door lock.

Vehicle key apparatus comprises vehicle door locks that no one can be unlocked by a mechanical key.

Vehicle key apparatus comprises short distance RFID tag key readers on the outer wall of the vehicle or/and on or around the vehicle driver instrument panel and short distance RFID tag key carried by the people; wherein said tag key brushes said reader to perform one or more of unlocking and locking the vehicle door lock, unlocking and locking the anti-theft system lock, starting the engine, making the vehicle be in the running possible state, starting the air conditioner, unlocking the car glove box lock, and unlocking the cargo door lock.

Said short distance RFID tag key is one or more of an un-powered contactless card-shaped RFID tag key, an un-powered contactless key-plate-shaped RFID tag key, and a powered RFID tag key.

Said short distance powered RFID tag key is a special key or one function of one or more of the multi-functional electric appliance of a telephone, a smartphone, a tablet computer, a computer, a smart watch, a digital camera and a digital multimedia player.

When said short distance RFID tag key brushes said RFID reader, one or more of the following results are achieved: (1) within a set time after the lock is unlocked, one or more of opening the door, starting the engine, making the vehicle be in the running possible state, starting the air conditioner, unlocking the car glove box lock, and unlocking the cargo door lock are operated; (2) if no said operation is done within the set time after the lock is unlocked, the lock is locked automatically with or without the announce in advance when the set time passes; and (3) said lock is locked.

Vehicle key apparatus comprises a retaining container of said RFID tag key around said short distance RFID tag key reader on or around the vehicle driver instrument panel.

The anti-theft system lock is unlocked when said RFID tag key is in said retaining container.

When said RFID tag key leaves said retaining container, one or more of the following results are achieved: (1) when the engine is in the state of stopping running, the anti-theft system lock is locked; and (2) when the engine is running, the anti-theft system lock is not locked, and an alarm is given.

Vehicle key apparatus comprises a biometric characteristic recognizer on the outer wall of the vehicle or/and on or around the vehicle driver instrument panel; wherein said biometric characteristic is used by the people to perform one or more of unlocking and locking the vehicle door lock, unlocking and locking the anti-theft system lock, starting the engine, making the vehicle be in the running possible state, starting the air conditioner, unlocking the car glove box lock, and unlocking the cargo door lock.

Said electronic combination keyboard, portable electronic key, said RFID reader, and said biometric recognizer are constructed integrally or separately, share the same power supply or use the power supply separately, use two or three of the combination, a RFID recognition tag and the biometric characteristic, perform one or more of unlocking and locking the anti-theft system lock, unlocking and locking the vehicle door lock, starting the engine, making the vehicle be in the running possible state, starting the air conditioner, adjusting air conditioner temperature, unlocking the car glove box lock, unlocking the cargo door lock and reading recorder data.

### BRIEF DESCRIPTION OF THE DRAWINGS

FIG. 1 shows a key assembly of an electronic combination keyboard with a solar panel and a short distance RFID tag key reader.

FIG. 2 shows an anti-theft starting switch, which belongs to a separate type or a button type, and is consisted of an engine switch, an anti-theft system lock switch and an extending switch.

FIG. 3 shows a separate button type anti-theft starting switch, which is consisted of the engine switch and the anti-theft system lock switch.

FIG. 4 shows a knob and button composite anti-theft starting switch, which is consisted of the engine switch, the anti-theft system lock switch and the extending switch.

FIG. 5 shows a knob and button composite anti-theft starting switch, which is consisted of the engine switch, the anti-theft system lock switch and the extending switch.

FIG. 6 shows that the key assembly of the electronic combination keyboard and the short distance RFID tag key reader is arranged on an outer wall of a car.

### DETAILED DESCRIPTION OF THE INVENTION

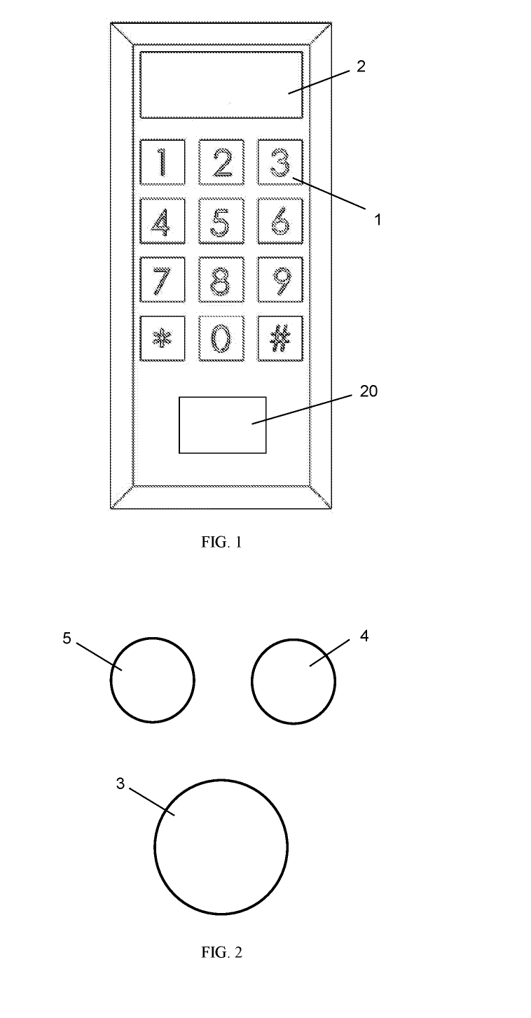

An electronic combination keyboard arranged on an outer wall of a car is provided to a vehicle key apparatus as a car key. FIG. 1 shows a typical key assembly of an electronic combination keyboard and a short distance RFID tag key reader, 1 is a keypad, and 2 is a solar panel. 20 is the short distance RFID tag key reader. It is convenient for the solar panel of the key assembly to power the rechargeable battery in the daytime outdoors, so it is suitable for the key assembly to be arranged on an outer wall of a vehicle. The key assembly can also use an internal power supply of the vehicle and an assembly built-in battery power supply. The power supply of the key assembly can also be powered by one or more of a manual mechanical power generation assembly, a thermoelectric power generation assembly, and an external power supply connected with an external power supply socket arranged on the vehicle. Multiple power supply modes are employed, so that when one power supply mode fails to work, another mode can also supply power. This guarantees that the key assembly of the electronic combination keyboard and the short distance RFID tag key reader can be continuously supplied power and perform work. The short distance refers to the distance less than about 5 cm herein. The electronic combination keyboard on the outer wall of the car refers to that people can perform a combination operation outside the car. Some electronic combination keyboards are arranged inside a car window glass, but the combination operation is also required to be performed outside the car. The solar power generation assembly is consisted of the solar panel of a power generation component and a rechargeable battery or capacitor of a power storage component. In general, the power storage time of the rechargeable battery is longer than that of the capacitor, thus the rechargeable battery is better. The rechargeable battery can be powered by the internal power supply of the car. The internal power supply of the car is powered by a generator and an engine ignition battery of the car.

The electronic combination keyboard arranged on the outer wall of the car is used as the car key, which can unlock a car door lock, unlock a car anti-theft system lock, start a car engine, make the vehicle be in a running possible state, start an air conditioner, adjust a set air conditioner temperature, unlock a car glove box lock, and unlock a cargo door lock, without a need of carrying the key. However, when a person unlocks the car door lock without the key, it is not convenient enough to arrange the electronic combination keyboard on the outer wall of the car, because it is not convenient for the person to operate the electronic combination keyboard on the outer wall of the car when he or she enters into the car. Thus, one electronic combination keyboard is also required to be arranged on or around an instrument panel inside the car. The electronic combination keyboard can be special, and can also be a car multi-functional video device, such as one function of a car television, a car stereo, a car navigator and the like. The around refers to the position that the fingers of the driver sitting on the seat can reach conveniently. The power supply employs the internal power supply of the vehicle or a keyboard built-in battery. The anti-theft system lock herein includes an engine lock, a transmission lock, a power supplying lock, a fuel supplying lock, a video device power supply lock, a satellite navigator power supply lock, various detector power supply locks and the like, which are mainly locks inside the car. The anti-theft system lock herein doesn't include the car door lock, the cargo door lock, the car glove box lock and the like. Unlocking the car door lock herein refers to unlocking the anti-theft portion of the car door lock. Some car door locks can induct with the car through the key and unlock the anti-theft portion of the car door lock, and the anti-theft portion is electronic. Then a button is pressed at the handle outside the car to unlock the mechanical portion of the door lock, wherein the button has no anti-theft function. Only when both the anti-theft portion and the mechanical portion are unlocked can the car door be opened with the handle. When the door lock is unlocked inside the car, there is no need to unlock the anti-theft portion, and unlocking the mechanical portion that is not anti-theft directly can open the door. However, the door-locking operation herein refers to locking both the anti-theft portion and the mechanical portion.

The two electronic combination keyboards arranged on the outer wall of the car and inside the car can be easy to be removed, and can be difficult to be removed. It is convenient for the electronic combination keyboard that is difficult to be removed to communicate with a car anti-theft system lock device with a wired communication employing a rolling code and a fixed code. For the electronic combination keyboard that is easy to be removed, it is better to employ a wireless communication employing the rolling code. The keypad of the electronic combination keyboard can be a mechanical keypad or a touch keypad.

The portable electronic key that is carried by the people can perform a remote control operation and an induction operation, and has a great advantage. The current car remote control keys and keyless starting system keys are all special portable electronic keys without the combination keyboards. If the combination keyboard is added, protection by the combination can also be obtained when the key is lost. The portable electronic key can be one function of one or more of the multi-functional electric appliance of a telephone, a smartphone, a tablet computer, a computer, a smart watch, a digital camera, a digital multimedia player and the like.

Between the portable electronic key and the vehicle anti-theft system lock device, one or more communication mode of a RFID communication employing a rolling mode, a radio frequency communication, an infrared light communication, a Bluetooth communication, a WIFI communication, a telephone ground-based communication and a telephone satellite communication is(are) used, one or both of a wireless communication operated by the keypad and an approaching wireless induction is(are) provided, and one or both of using the combination and using no combination is(are) employed to perform one or more of unlocking and locking the anti-theft system lock, unlocking and locking the vehicle door lock, starting and stopping the engine, making the vehicle be in the running possible state, starting the air conditioner, adjusting the set air conditioner temperature, unlocking the car glove box lock, unlocking the cargo door lock and reading the recorder data.

As a key, the combination of the combination keyboard can be the number with 1 to 32 digits, with a * and a # respectively added in front of and behind of the number. A set of examples are as follows:
*123451#: unlocking the vehicle door lock with the combination
*1#: locking the vehicle door lock with the combination
*123452#: unlocking the anti-theft system lock with the combination
*2#: locking the anti-theft system lock with the combination
*123453#: starting the engine with the combination
*3#: stopping the engine with the combination
*124#20#: starting the air conditioner with the combination, setting the temperature as 20 degree Celsius, or updating the set temperature of the air conditioner to 20 degree Celsius.
*4#: stopping the air conditioner with the combination
*123455#: unlocking the car glove box lock with the combination
*123456#: unlocking the cargo door lock with the combination
*123457#: reading the recorder data with the combination
#: stopping the engine, stopping the air conditioner, locking the anti-theft system lock and locking the vehicle door lock

When the vehicle door lock and the anti-theft system lock are in the unlocked state at the same time, the vehicle is in the running possible state.

The combination operation takes a long time, so an anti-theft system lock unlocked state extending switch is arranged on or around the vehicle driver instrument panel to reduce the combination operation and increase convenience.

For convenience in operation of a vehicle key apparatus, an anti-theft starting switch is arranged on or around the vehicle driver instrument panel. The anti-theft starting switch can be a pure switch, or a complex type switch, which includes the engine switch, the anti-theft system lock switch and the extending switch. The complex type switch can be one of the following kinds: (1) different positions in the same knob, (2) different positions in the same translation button, (3) different positions in the same button, (4) different button hold times in the same button, (5)different times of the button to be pressed during a set time in the same button, (6) an operating button consisting of one or more of the operations of pressing, rotating and translating the button, and (7) a separated operating button in the button, the knob and the translation button. The operation of the engine switch can work only when the anti-theft system lock is in the unlocked state. When the anti-theft system lock is not unlocked, the engine switch can not work.

As to the electronic combination keyboard arranged on the outer wall of the vehicle, the combination is input to unlock the door lock, and as to the portable electronic key, the combination or no combination is input to unlock the door lock. Then, within a set time A, such as 1 minutes, and before the people's entering into the car or after the people's entering into the car, the electronic combination keyboard arranged on the outer wall of the vehicle, or arranged on or around the vehicle driver instrument panel is used, and the anti-theft system lock combination is input to unlock the anti-theft system lock; or the portable electronic key is used, and the anti-theft system lock combination or no combination is used to unlock the anti-theft system lock.

When the vehicle stops running and the engine is in the running state, the engine switch is operated to stop the engine until the anti-theft system lock is in the unlocked state.

When the anti-theft system lock is in the unlocked state, and within a set time B, such as 2 minutes, the engine switch is operated to start the engine, or the extending switch is operatd to extend the anti-theft system unlocked state time, or the anti-theft system lock switch is operated to lock the anti-theft system.

As to the set time A and B, the operation isn't done in the set time A, and when the set time A passes, the vehicle door lock is locked automatically with or without an acousto-optic announce in advance. The operation isn't done in the set time B, and when the set time B passes, the anti-theft system lock is locked automatically with or without an acousto-optic announce in advance.

For convenience, a state indicator light is arranged on the car instrument panel, the engine switch and the like. When the anti-theft system lock is in a locked state, the indicator light displays no light. When the anti-theft system lock is in the unlocked state, and the engine doesn't run, the indicator light displays a yellow light. When the anti-theft system lock is in the unlocked state, and the engine is running, the indicator light displays a green light. When the engine is running, and the door lock is in the locked state, the indicator light displays a red light. When the red light is displayed, the car can not run, and when the engine and the air conditioner are started by remote control, an anti-theft function is played. When the anti-theft system lock herein is in the unlocked state, the engine can be started and stopped.

FIG. 2 shows an anti-theft starting switch, which belongs to a separate type or a button type, and is consisted of the engine switch, the anti-theft system lock switch and the extending switch. 3 is the engine switch, 4 is the anti-theft system lock switch, and 5 is the anti-theft system lock unlocked state extending button. For convenience, the switch 3, the switch 4 and the button 5 have the state indicator lights. When the anti-theft system lock is in the unlocked state where the indicator light displays the yellow light, the engine switch 3 is pressed, the engine is started, and the indicator light displays the green light. For safety, when the vehicle is running, even if the engine switch 3 is pressed, it still can not work. When the vehicle stops running, and the engine is running where the indicator light displays the green light, the engine switch 3 is pressed to stop the engine until the anti-theft system lock is in the unlocked state, and the indicator light displays the yellow light. The yellow lights can be displayed at the same time at the anti-theft system lock switch, the engine switch and the instrument panel. When the anti-theft system lock is in the unlocked state where the indicator light displays the yellow light, the anti-theft system lock switch 4 is pressed to lock the anti-theft system and turn off the indicator light. When the anti-theft system is in the unlocked state where the yellow light is displayed, the extending button 5 is pressed to extend the anti-theft system lock unlocked state time, the extended time can be set, and before the set time is reached, such as 5 seconds, the indicator light of the button 5 flashes, and the vehicle gives a sounding prompting signal.

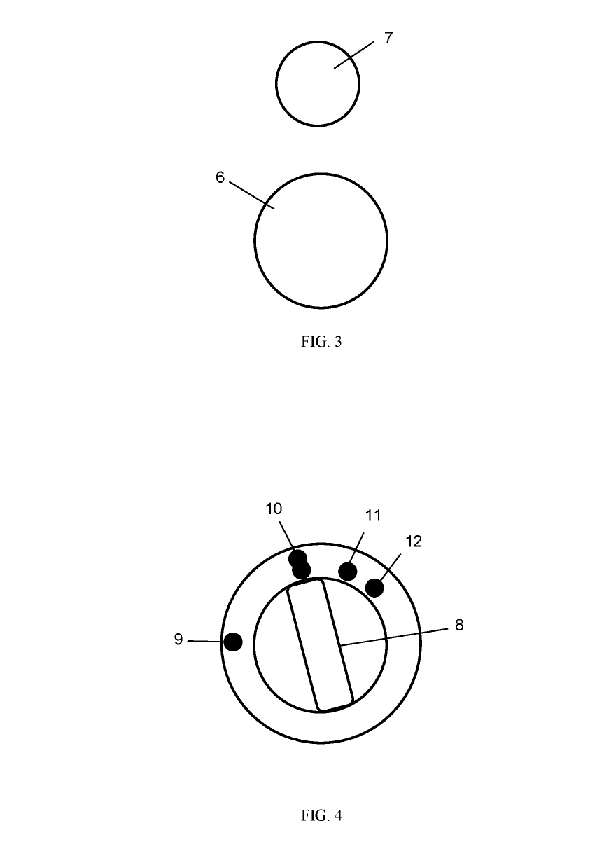

FIG. 3 shows another separate button type anti-theft starting switch, which is consisted of the engine switch and the anti-theft system lock switch. 6 is the engine switch, and 7 is the extending switch. When the anti-theft system lock is in the unlocked state where the indicator light displays the yellow light, the engine switch 6 is pressed, the engine is started, and the indicator light displays the green light. When the vehicle stops running, and the engine is running where the indicator light displays the green light, the engine switch 6 is pressed for a short time to stop the engine until the anti-theft system lock is in the unlocked state and the indicator light displays the yellow light, and it is pressed for more than 3 seconds to lock the anti-theft system lock and turn off the indicator light displaying the green light. When the anti-theft system is in the unlocked state where the yellow light is displayed, the extending switch 7 is pressed for a short time to extend the unlocked state time, and it is pressed for more than 3 seconds to lock the anti-theft system lock and turn off the indicator light. In addition, when the vehicle stops running and the engine is running where the indicator light displays the green light, the switch 6 and 7 are pressed at the same time to lock the anti-theft system lock and turn off the indicator light displaying the green light.

The extending switch in FIG. 3 can be omitted, can only one engine switch is kept. When the anti-theft system lock is in the unlocked state where the indicator light displays the yellow light, the engine switch is pressed, the engine is started, and the indicator light displays the green light. When the vehicle stops running, and the engine is running where the indicator light displays the green light, the engine switch is pressed for a short time to stop the engine until the anti-theft system lock is in the unlocked state and the indicator light displays the yellow light, and it is pressed for more than 3 seconds to lock the anti-theft system lock and turn off the indicator light. When the anti-theft system lock is in the unlocked state where the indicator light displays the yellow light, the engine switch is half pressed to extend the unlocked state time.

FIG. 4 shows a knob and button composite anti-theft starting switch, which is consisted of the engine switch, the anti-theft system lock switch and the extending switch. 8 is the knob, 9 is a knob nonstop position locking the anti-theft system lock, 10 is a knob stop position of the anti-theft system lock, 11 is the knob stop position when the engine is running, and 12 is the knob nonstop position starting the engine. When the anti-theft system lock is in the unlocked state where the indicator light displays the yellow light, the knob is twisted by hand from the position 10, and through the position 11, to the position 12 to start the engine and make the indicator light display the green light, and the knob is released and automatically returns to the position 11 to keep the engine running and the green light displayed. When the vehicle stops running, and the engine is running where the indicator light displays the green light, the knob is twisted by hand from the position 11 to the position 10 to stop the engine until the anti-theft system lock is in the unlocked state, and the indicator light displays the yellow light. When the anti-theft system lock is in the unlocked state where the yellow light is displayed, the knob is twisted by hand to the position 10 and pressed to extend the unlocked state time. When the knob is pressed at the position 10 and twisted to the position 9, the anti-theft system lock is locked and the indicator light is turned off, and when the knob is released and automatically returns to the position 10, the anti-theft system lock is kept locked, and the indicator light is turned off.

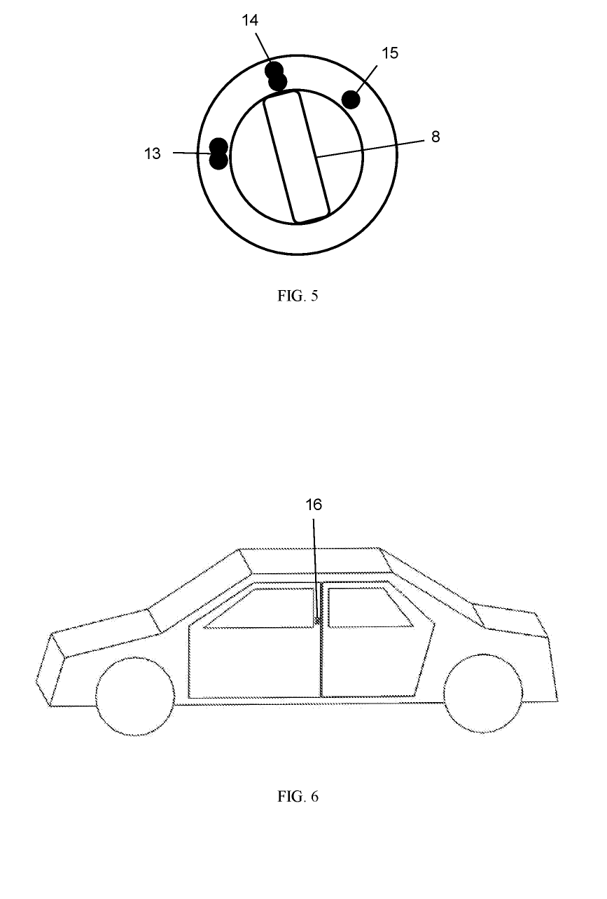

FIG. 5 shows a knob and button composite anti-theft starting switch, which is consisted of the engine switch, the anti-theft system lock switch and the extending switch. 13 is a knob nonstop position stopping the engine and locking the anti-theft system lock, 14 is a knob stop position unlocking the anti-theft system lock, keeping the engine running and extending the engine's running, and 15 is the knob nonstop position starting the engine. When the anti-theft system lock is in the unlocked state where the indicator light displays the yellow light, the knob is twisted by hand from the position 14 to the position 15 to start the engine and make the indicator light display the green light, and the knob is released and automatically returns to the position 14 to keep the engine running and the green light displayed. When the vehicle stops running and the engine is running where the indicator light displays the green light, the knob is twisted by hand from the position 14 to the position 13, wherein when the knob is kept at the position 13 for a short time, the engine is stopped until the anti-theft system lock is in the unlocked state and the indicator light displays the yellow light, and the knob is released and returns to the position 14 to keep the anti-theft system lock in the unlocked state and the the yellow light displayed, and when the knob is kept at the position 13 for a long time, such as more than 3 seconds, the engine is stopped until the anti-theft system lock is locked and the indicator light is turned off, and the knob is released and returns to the position 14 to keep the anti-theft system lock locked and the indicator light turned off. When the anti-theft system lock is in the unlocked state where the yellow light is displayed, the knob is pressed at the position 14 to extend the unlocked state time.

When the door-locking operation is done outside or inside the car, one or more of the following results is(are) achieved: (1) when the engine stops running and the anti-theft system lock is in the unlocked state, the vehicle door undergoes processes of being opened and closed, and when the door is locked, the door lock and the anti-theft system are locked at the same time; (2) when the engine stops running and the anti-theft system lock is in the unlocked state, the vehicle door doesn't undergo the processes of being opened and closed, and when the door is locked, the anti-theft system isn't locked; (3) when the engine is running, the vehicle door undergoes or doesn't undergo the processes of being opened and closed, and when the door is locked, the engine doesn't stop and the anti-theft system isn't locked; and (4) when the engine is in the state of stopping running, the vehicle door is in an opening state, when the door is locked, the anti-theft system is locked, and when the door is closed again, the door lock is locked.

Door opening operation and door closing operation of the vehicle can achieve one or more of the following results: (1) when the engine stops running, the vehicle door undergoes the processes of being opened and closed, and after the set time C, such as 3 minutes, the anti-theft system is locked automatically, and the door is locked automatically; and (2) when the engine is running, the door opening operation and the door closing operation don't stop the engine and don't lock the anti-theft system.

FIG. 6 shows that the key assembly of the electronic combination keyboard and the short distance RFID tag key reader is arranged on the outer wall of the car. When a person leaves the car, he or she doesn't need to carry the cay key, and when the person needs to drive the car, he or she comes to the near of the car, inputs the car door lock combination on the combination key to unlock the door lock, inputs the car anti-theft system lock combination to unlock the anti-theft system lock, enters into the car, operates the engine switch to start the engine, and drives the car. When the destination is reached, the person stops driving, stops the engine, locks the anti-theft system lock, opens the car door, comes out of the car, closes the door, locks the door, and leaves the car without the need of carrying the car key.

From the anti-theft perspective, when the anti-theft system and the door lock of the vehicle are locked, a window is closed automatically.

Manual operation is better than automatic operation, since after the anti-theft system and the door lock of the car are locked, and when the person is in the vehicle, he or she can perform the operations of opening or closing the window. When the person is outside of the vehicle, he or she can perform the operations of opening or closing the window by remote control.

The portable electronic key, or the special key without or with the electronic combination keyboard, or one function of one or more of the multi-functional electric appliances of the telephone, the smartphone, the tablet computer, the computer, the smart watch, the digital camera and the digital multimedia player, with a keyless starting chip built in, performs one or more of the following operations through a chip induction to a keyless starting system car: (1) when the combination is carries by a person and approaches the automobile for a certain distance, such as 50 centimeters, the door lock is unlocked automatically and the door lock indicator light displays the green light; (2) when the combination key enters into the car, the anti-theft system lock is unlocked automatically and the anti-theft system indicator light displays the yellow light, then within a set time B, the engine switch is operated to start the engine, or the extending switch is operated to extend the anti-theft system unlocked state time, or the anti-theft system lock is operated to lock the anti-theft system, and if no such operations are done during the set time B, when the set time B passes, with or without an acousto-optic announce in advance, the anti-theft system lock is locked automatically, the indicator light is turned off, and the anti-theft system lock can be unlocked again through a manual key operation; (3) when the engine stops running and the combination key leaves the car, the anti-theft system lock is locked automatically and the indicator light is turned off; (4) when the engine is running, the combination key exits the car, the engine isn't stopped, the anti-theft system isn't locked, and the car gives or doesn't give the prompting message that the combination key exits the car; (5) when the combination key leaves the car for a certain distance, such as 50 centimeters, the door lock is locked automatically, and the door lock indicator light is turned off; and (6) the combination key has one or more of a hardware operation key and a software operation key, and the result of the manual key operation has precedence over that of an automatic operation.

The portable electronic key with or without the electronic combination keyboard, or the electronic combination keyboard arranged on the outer wall of the vehicle, doesn't unlock the vehicle door lock, with the input of the combination or no combination, directly starts the engine, wherein an engine indicator light displays the green light, and the door lock indicator light displays the red light, and then the air conditioner combination or no combination is input to start the air conditioner and adjust the set air conditioner temperature. The vehicle door lock is not unlocked and engine is directly started; the vehicle is not in the running possible state automatically; if the vehicle is also wished to run, the vehicle door lock combination or no combination is required to be input to unlock the vehicle door lock, and the vehicle can run only when the door lock indicator light displays the green light. The vehicle can not run either if the vehicle door lock isn't unlocked by the portable electronic key or the electronic combination keyboard on the outer wall, but for example is pried. In this way, the vehicle internal temperature can be adjusted in advance, and a good anti-theft performance can be kept. When the vehicle door lock isn't unlocked, and the engine is started directly, if the vehicle door lock isn't unlocked by the portable electronic key or the electronic combination keyboard arranged on the outer wall, the engine and the air conditioner stop running automatically after a set time, such as 10 minutes.

Thus, when the door lock and the anti-theft system lock are in the locked states at the same time, the electronic combination keyboard arranged on the vehicle or the portable electronic key only unlocks the anti-theft system lock, starts or doesn't start the engine, and can not make the vehicle be in the running possible state.

When the door lock and the anti-theft system lock are in the locked states at the same time, the anti-theft system lock is unlocked first, the engine or the air conditioner is started or isn't started, and the door lock is unlocked to make the vehicle in the running possible state.

A rotary mechanical password door lock or a keypad type mechanical password door lock is arranged on the outer wall of the vehicle to unlock the vehicle door lock. The mechanical password door lock needs no keys, which is convenient.

The use of the mechanical password door lock makes the mechanical door lock using the mechanical key unnecessary, and saves the chore of carrying the mechanical key.

It is convenient for the master to use the combination, but it is not convenient for the master to lend it to guests. For the convenience of lending the key to the guests, the short distance RFID tag key reader is arranged on the outer wall of the vehicle, or/and arranged on or around the vehicle driver instrument panel. The short distance RFID tag key carried by the master or the guest is used to brush the RFID reader to perform one or more of unlocking and locking the vehicle door lock, unlocking and locking the anti-theft system lock, starting the engine, making the vehicle be in the running possible state, starting the air conditioner, unlocking the car glove box lock, and unlocking the cargo door lock.

The short distance RFID tag key is an un-powered contactless card-shaped RFID tag key, an un-powered contactless key-card-shaped RFID tag key, and a powered RFID tag key.

The short distance powered RFID tag key is the special key, or one function of the multi-functional electric appliance of the telephone, the smart phone, the tablet computer, the computer, the smart watch, the digital camera, the digital multimedia player and the like, which have the RFID chips built in.

When the short distance RFID tag key brushes the RFID reader, it gives the acousto-optic indication, and one or more of the following results can be achieved according to the time and times of brushing the RFID reader, and a state of the lock: (1) one or more of opening the door, starting the engine, making the vehicle be in the running possible state, starting the air conditioner, unlocking the car glove box lock, and unlocking the cargo door lock is(are) operated within a set time after the lock is unlocked; (2) if no said operation is done within the set time after the lock is unlocked, the lock is locked automatically with or without the announce in advance when the set time passes; and (3) the lock is locked.

A retaining container of the RFID tag key is provided around a car internal short distance RFID tag key reader, and the RFID tag key is put into the retaining container after the people's entering the car to avoid the loss of the key.

The anti-theft system lock is unlocked when the RFID tag key is in the retaining container. The retaining container can be a card slot, or a basin-like object. The RFID tag key in the retaining container will not leave it because of a vibration or a braking.

The RFID tag key can be removed from the retaining container, and when it leaves the retaining container, one or more of the following results can be achieved according to different states: (1) when the engine is in the state of stopping running, the anti-theft system lock is locked; and (2) when the engine is running, the anti-theft system lock isn't locked, and an acousto-optic alarm is given.

The biometric characteristic has its distinct advantages as the key. Thus, the biometric characteristic recognizer is arranged on the outer wall of the vehicle, or/and on or around the vehicle driver instrument panel, and the biometric characteristic is used by the people to perform one or more of unlocking and locking the vehicle door lock, unlocking and locking the anti-theft system lock, starting the engine, making the vehicle be in the running possible state, starting the air conditioner, unlocking the car glove box lock, and unlocking the cargo door lock. The biometric characteristic includes a finger print, a iris, a human face, a vein, a voice and so on.

The electronic combination keyboard, the portable electronic key, the RFID reader, and the biometric recognizer are constructed integrally or separately, and share the same power supply or use the power supply separately. Two or three of the combination, the RFID recognition tag and the biometric characteristic are combined for unlocking and locking the anti-theft system lock, unlocking and locking the vehicle door lock, starting the engine, making the vehicle be in the running possible state, starting the air conditioner, adjusting the set air conditioner temperature, unlocking the car glove box lock, unlocking the cargo door lock, reading the recorder data, which has a higher anti-theft performance.

1. Vehicle key apparatus comprising:
electronic combination keyboards both on an outer wall of the vehicle and on or around a vehicle driver instrument panel;
wherein said keyboard is touch keypad or mechanical keypad;
and through combination operation, said keyboards performs one or more of unlocking and locking the vehicle door lock, unlocking and locking the anti-theft system lock, starting and stopping an engine, making the vehicle be in a running possible state, starting an air conditioner, adjusting air conditioner temperature, unlocking a car glove box lock, and unlocking a cargo door lock.

2. Vehicle key apparatus according to claim 1, wherein said keyboard on the outer wall of the vehicle, whether it is powered by an internal power supply of the vehicle, is powered by one or more of a solar power generation assembly, a manual mechanical power generation assembly, a thermoelectric power generation assembly, a battery removable from the outside, and an external power supply connected to an external power supply socket;
said keyboard on or around the vehicle instrument panel is special, or is one function of a multi-functional audio or video device of the car, and is powered by one or both of the internal power supply of the vehicle and a special battery of the keyboard;
and between said keyboards and the vehicle anti-theft system lock device, one or more of a wired communication employing rolling codes and fixed codes, and a wireless communication employing rolling codes are used.

3. Vehicle key apparatus according to claim 1, comprising:
A portable electronic key, which is the remote control key without or with the electronic combination keyboard, or the keyless starting system key, or one function of one or more of the multi-functional electric appliance of a telephone, a smartphone, a tablet computer, a computer, a smart watch, a digital camera and a digital multimedia player;
wherein between said portable electronic key and the vehicle anti-theft system lock device, one or more communication modes of a RFID communication, a radio frequency communication, an infrared light communication, a Bluetooth communication, a WIFI communication, a telephone ground-based communication and a telephone satellite communication are used; one or both of a wireless communication operated by the keypad and an approaching wireless induction are provided; one or both of using the combination and not using the combination are used; to perform one or more of unlocking and locking the anti-theft system lock, unlocking and locking the vehicle door lock, starting and stopping the engine, making the vehicle be in the running possible state, starting the air conditioner, adjusting air conditioner temperature, unlocking the car glove box lock, unlocking the cargo door lock and reading recorder data.

4. Vehicle key apparatus comprising:
an anti-theft system lock unlocking extending switch near vehicle engine switch.

5. Vehicle key apparatus according to claim 4, comprising:
an anti-theft starting switch on or around the driver instrument panel of the vehicle;
wherein said switch has one or more of said engine switch, anti-theft system lock switch and said extending switch, and is one of the following kinds: (1) different positions in the same knob, (2) different positions in the same translation button, (3) different positions in the same button, (4) different button hold times in the same button, (5)different times of the button to be pressed during a set time in the same button, (6) an operating button consisting of one or more of the operations of pressing, rotating and translating the button, and (7) a separated operating button in the button, the knob and the translation button.

6. Vehicle key apparatus according to claim 5, wherein after said keyboard on the outer wall of the vehicle or said portable electronic key is used to unlock the door lock with the input of a vehicle door lock combination or without the input of a combination and within a set time A, before people's entering into the car, or after people's entering into the car, said keyboard on the outer wall of the vehicle or on or around the vehicle driver instrument panel, or said portable electronic key is used to unlock the anti-theft system lock with the input of the anti-theft system lock combination or without the input of the combination; then within a set time B, said engine switch is operated to start the engine, or said extending switch is operated to extend an anti-theft system unlocked state time, or said anti-theft system lock switch is operated to lock the anti-theft system;
within said set time A, if no operation is done, and when said set time A passes, said vehicle door lock is locked automatically with or without an announce in advance;
and within said set time B, if no operation is done, and when the set time B passes, said anti-theft system lock is locked automatically with or without an announce in advance.

7. Vehicle key apparatus according to claim 5, wherein when said vehicle stops running and the engine is in running state, said engine switch is operated to stop the engine to the unlocked state of the anti-theft system lock. Then within a set time B, said engine switch is operated to start the engine, or said extending switch is operated to extend the anti-theft system lock unlocked state time, or said anti-theft system lock switch is operated to lock the engine.

8. Vehicle key apparatus according to claim 1, wherein said door-locking operation of the vehicle achieves one or more of the following results: (1) when the engine stops running and the anti-theft system lock is in an unlocked state, and the vehicle door undergoes processes of being opened and closed, said door-locking operation locks the door lock and the anti-theft system at the same time; (2) when the engine stops running and the anti-theft system lock is in the unlocked state, and the vehicle door does not undergo the processes of being opened and closed, said door-locking operation does not lock the anti-theft system; (3) when the engine is running, and the vehicle door undergoes or doesn't undergo the processes of being opened and closed, said door-locking operation does not stop the engine and does not lock the anti-theft system; and (4) when the engine is in the state of stopping running, and the vehicle door is in an opening state, said door-locking operation locks the anti-theft system, and then if do the door close operation, the door lock also locks automatically.

9. Vehicle key apparatus according to claim 1, wherein said door opening and closing operation of the vehicle achieves one or more of the following results: (1) when the engine stops running, said door opening and closing operation locks the anti-theft system and the door automatically after the set time C; and (2) when the engine is running, said door opening and closing operation does not stop the engine and does not lock the anti-theft system.

10. Vehicle key apparatus according to claim 1, wherein said operation of locking both anti-theft system and door lock, also closes all of vehicle windows automatically.

11. Vehicle key apparatus according to claim 3, wherein said portable electronic key undergoes one or more of the following operations through an induction with the vehicle within a set time after an input of combination or an input of no combination: (1) when said portable electronic key approaches the automobile for a certain distance, the door lock is unlocked automatically; (2) when said portable electronic key enters the car, the anti-theft system lock is unlocked automatically; (3) when the engine stops running and said portable electronic key exits the car, the anti-theft system lock is locked automatically; (4) when the engine is running, said portable electronic key exits the car, the engine is not stopped, the anti-theft system is not locked, and the car gives or does not give the prompting message that said portable electronic key exits the car;
(5) when said portable electronic key leaves the car for a certain distance, the door lock is locked automatically; and (6) said portable electronic key has one or more of a hardware operation key and a software operation key, and the result of a manual operation has precedence over that of an automatic operation.

12. Vehicle key apparatus according to claim 1, comprising:
an electronic combination keyboard on the vehicle or portable electronic key;
wherein when the door lock and the anti-theft system lock are in locked states at the same time, with said keyboard or said portable electronic key, only unlocking operation of the anti-theft system lock, starting or not starting the engine, does not make the vehicle be in the running possible state.

13. Vehicle key apparatus according to claim 1, comprising:
an electronic combination keyboard on the vehicle or portable electronic key;
wherein when the door lock and the anti-theft system lock are in locked states at the same time, with said keyboard or said portable electronic key, first unlocking the anti-theft system lock, starting or not starting the engine or the air conditioner, then unlocking the door lock make the vehicle be in the running possible state.

14. Vehicle key apparatus according to claim 1, comprising:
a rotary mechanical password door lock or a keypad type mechanical password door lock on the outer wall of the vehicle, to unlock the vehicle door lock.

15. Vehicle key apparatus according to claim 1, comprising:
vehicle door locks that no one can be unlocked by a mechanical key.

16. Vehicle key apparatus comprising:
short distance RFID tag key readers on the outer wall of the vehicle or/and on or around the vehicle driver instrument panel and short distance RFID tag key carried by the people;
wherein said tag key brushes said reader to perform one or more of unlocking and locking the vehicle door lock, unlocking and locking the anti-theft system lock, starting the engine, making the vehicle be in the running possible state, starting the air conditioner, unlocking the car glove box lock, and unlocking the cargo door lock;
said short distance RFID tag key is one or more of an un-powered contactless card-shaped RFID tag key, an un-powered contactless key-plate-shaped RFID tag key, and a powered RFID tag key;
and said short distance powered RFID tag key is a special key or one function of one or more of the multi-functional electric appliance of a telephone, a smartphone, a tablet computer, a computer, a smart watch, a digital camera and a digital multimedia player.

17. Vehicle key apparatus according to claim 16, wherein when said short distance RFID tag key brushes said RFID reader, one or more of the following results are achieved: (1) within a set time after the lock is unlocked, one or more of opening the door, starting the engine, making the vehicle be in the running possible state, starting the air conditioner, unlocking the car glove box lock, and unlocking the cargo door lock are operated; (2) if no said operation is done within the set time after the lock is unlocked, the lock is locked automatically with or without the announce in advance when the set time passes; and (3) said lock is locked.

18. Vehicle key apparatus according to claim 16, comprising a retaining container of said RFID tag key around said short distance RFID tag key reader on or around the vehicle driver instrument panel;
wherein the anti-theft system lock is unlocked when said RFID tag key is in said retaining container;
and when said RFID tag key leaves said retaining container, one or more of the following results are achieved: (1) when the engine is in the state of stopping running, the anti-theft system lock is locked; and (2) when the engine is running, the anti-theft system lock is not locked, and an alarm is given.

19. Vehicle key apparatus according to claim 1, comprising a biometric characteristic recognizer on the outer wall of the vehicle or/and on or around the vehicle driver instrument panel;
wherein said biometric characteristic is used by the people to perform one or more of unlocking and locking the vehicle door lock, unlocking and locking the anti-theft system lock, starting the engine, making the vehicle be in the running possible state, starting the air conditioner, unlocking the car glove box lock, and unlocking the cargo door lock;

20. Vehicle key apparatus according to claim 19, wherein said electronic combination keyboard, portable electronic key, RFID reader, and said biometric recognizer are constructed integrally or separately, share the same power supply or use the power supply separately, use two or three of the combination, a RFID recognition tag and the biometric characteristic, perform one or more of unlocking and locking the anti-theft system lock, unlocking and locking the vehicle door lock, starting the engine, making the vehicle be in the running possible state, starting the air conditioner, adjusting air conditioner temperature, unlocking the car glove box lock, unlocking the cargo door lock and reading recorder data.
